(19) United States
(12) Patent Application Publication
(10) Pub. No.: US 2015/0362925 A1
(43) Pub. Date: Dec. 17, 2015

(54) CONTROLLING ASPECTS OF POOLS AND SPAS

(71) Applicant: ZODIAC POOL SYSTEMS, INC., Vista, CA (US)

(72) Inventors: Dindo Uy, North Hollywood, CA (US); David Goldman, Carlsbad, CA (US); David Nibler, Vista, CA (US); E. Keith McQueen, Vista, CA (US)

(21) Appl. No.: 14/728,678

(22) Filed: Jun. 2, 2015

Related U.S. Application Data
(60) Provisional application No. 62/011,913, filed on Jun. 13, 2014.

(51) Int. Cl. G05D 7/06; H04W 8/24; G05B 15/02

(52) U.S. Cl. CPC G05D 7/0676; G05B 15/02; H04W 8/24

(57) ABSTRACT

Described are systems and methods for controlling pool and spa equipment. A device may communicate wirelessly with pool and spa controls directly (point-to-point) as well as indirectly, either via the Internet or as part of a local area network (LAN). The device may be a smart phone, tablet, or other appropriate apparatus.

### CROSS-REFERENCE TO RELATED APPLICATION

This application claims the benefit of and priority to U.S. Provisional Patent Application Serial No. 62/011,913, filed Jun. 13, 2014, and having the same title as appears above, the entire contents of which application are incorporated herein by this reference.

### FIELD OF THE INVENTION

This invention relates to systems, methods, equipment, and techniques for controlling one or more components of a recreational water circulation system or modifying one or more characteristics of the water contained within a vessel such as a pool or spa. The invention relates more particularly to special-purpose controllers which may function without need to receive instructions from any master controller.

### BACKGROUND OF THE INVENTION

Commonly-owned U.S. Patent Application Publication No. 2014/0064139 of McQueen, et al. (the “McQueen Application”), whose contents are incorporated herein in their entirety by this reference, illustrates and discloses various manners of controlling pool and spa equipment, for example. Mobile devices such as (but not limited to) conventional smart phones may communicate with equipment used to control pool and spa equipment. This communication occurs via the Internet and thus requires access thereto.

Additionally, applicants believe a system may exist in which a mobile device communicates with a network router, which in turn communicates with equipment used to control pool and spa equipment. Applicants do not concede that such a system, if it exists, qualities as prior art in the United States or elsewhere. Nevertheless, communication according to any such system would require access to a network router, which might not be present in every home or other facility or, even if present, might be password-protected or not functioning when needed.

### SUMMARY OF THE INVENTION

Unavailable is any system in which a device may communicate wirelessly with pool and spa control equipment both (1) via the Internet (or router as part of a local area network [LAN]) and (2) directly (i.e. point-to-point). Likewise unavailable is any system in which a mobile device, such as a smart phone, may utilize locally-implemented software (i.e. an “app”) to communicate either via the Internet or other network or directly with pool and spa control equipment. Further, if the control equipment is sufficiently capable, it may avoid any need for a master controller in the system.

The present invention provides all of these features currently unavailable. At least certain embodiments of the invention provide special-purpose, stand-alone controls not requiring communication with a master instructional device. The controls need not necessarily be special-purpose or stand-alone, however. Nevertheless, if they are, separate controllers may be used for each of a heating device, variable-speed pump, automatic pool cleaner, etc.

It thus is an optional, non-exclusive object of the present invention to provide a controller of pool or spa equipment which is configured to communicate directly (i.e. point-to-point) with a user device.

It also is an optional, non-exclusive object of the present invention to provide a controller of pool or spa equipment configured to communicate with a user device both directly and indirectly via a LAN or the Internet.

It is another optional, non-exclusive object of the present invention to provide a controller of pool or spa equipment in which at least some communication between it and a user device is wireless.

It is a further optional, non-exclusive object of the present invention to provide a controller of pool or spa equipment which communicates with a user device that is mobile.

It is an additional optional, non-exclusive object of the present invention to provide a controller of pool or spa equipment configured to communicate with a user device (1) directly, (2) indirectly via (at least) a router, and (3) indirectly via the internet without necessarily communicating with a router.

Other objects, features, and advantages of the present invention will be apparent to those skilled in the relevant art with reference to the remaining text and the drawing of this application.

### BRIEF DESCRIPTION OF THE DRAWING

FIG. 1 is a schematic representation of a system including aspects of the present invention.

### DETAILED DESCRIPTION

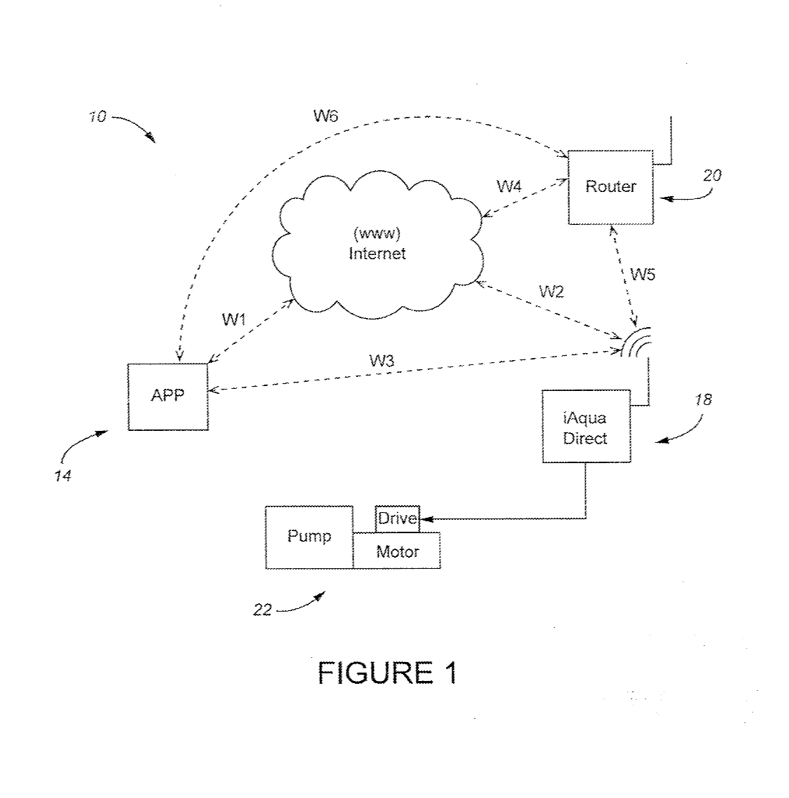

Illustrated in FIG. 1 is a schematic of an exemplary system 10 consistent . with the invention. System 10 may include device 14, controller 18, router 20, and equipment 22. Preferably, device 14 is a hand-held smart phone, tablet, or other mobile device capable of transmitting and receiving information wirelessly, accessing the Internet (WWW), and executing software programs known as “apps.” Device 14 need not necessarily be a hand-held or mobile device, however.

Controller 18 preferably includes functionality similar to the controllers of the McQueen Application. At minimum, controller 18 should be able to transmit and receive information wirelessly, access the Internet (WWW) at least via router 20, and control equipment 22 electronically. Controller 18 may communicate with equipment 22 either via wire (as shown in FIG. 1) or wirelessly; if equipment 22 is capable of sending information back to controller 18 (i.e. providing feedback), controller 18 may be configured to receive the feedback. Advantageously (but not necessarily), controller 18 is weatherproof and otherwise configured for outdoor use.

Depicted in FIG. 1 as equipment 22 may be a pump whose motor includes an electronic drive. Equipment 22 need not be a pump, however, Instead, as noted above, equipment 22 may be or include other components such as (but not limited to) heaters, pool cleaners, pool sanitizers, etc., capable of implementing instructions from a controller 18. Preferably, though, equipment 22 is configured for water of a pool or spa to flow through or by it.

Hence, a user of device H may communicate with controller 18 to control equipment 22 either via the Internet (using communications paths W1, W4, and W5) or directly (using communications path W3). Alternatively, device 14 may communicate directly with router 20 (using communications path W6) and thence with controller 18 (via path W5), Communication via the Internet may be especially advantageous when the user of device 14 is remote from equipment 22. By contrast, bypassing the Internet may be beneficial when the user of device 14 cannot access the Internet or a nearby router 20.

As an example, a pool servicing technician may desire to control equipment 22 on-site temporarily for troubleshooting purposes or to ensure a hardware or software correction has been implemented correctly. Even if the technician is unable to access the Internet or router 20, he or she may use a properly-credentialed device 14 to bypass communications paths W1, W4, and W5 and communicate directly with controller 18 via path W3. Further, this direct communication may occur without resetting controller 18, so the controller 18 may continue to recognize appropriate Internet-based communications occurring via paths W4 and W5. Indeed, subject to implementation of appropriate rules should it receive conflicting information, controller 18 may communicate via paths W4 and W5, paths W6 and W5, and path W3 (and with more than one properly-credentialed device 14) simultaneously if desired.

In at least some versions of the invention, controller 18 may include a (real or virtual) pushbutton switch or other means allowing a user to select among its communications paths W3 or W5. Controller 18 also beneficially may utilize the RS-485 protocol in communicating with equipment 22. The equipment 22 optionally may include dual in-line package (DIP) switches that may be set for this purpose.

The foregoing is provided for purposes of illustrating, explaining, and describing embodiments of the present invention. Modifications and adaptations to these embodiments will be apparent to those skilled in the art and may be made without departing from the scope or spirit of the invention. As one (non-limiting) example of such a modification, controller 18 could be configured to connect directly to the Internet (see path W2) rather than via router 20.

What is claimed is:

1. A method of controlling pool or spa equipment, comprising:
a. providing a controller configured to communicate wirelessly directly with a mobile device;
b. communicatively connecting the controller to pool or spa equipment; and
c. transmitting information, from the mobile device to the controller, for further transmission to the pool or spa equipment.

2. A method of controlling pool or spa equipment according to claim 1 in which the controller is configured also to communicate wirelessly indirectly with the mobile device.

3. A method of controlling pool or spa equipment according to claim 2 in which indirect wireless communication between the controller and the mobile device may occur via a router disconnected from the Internet.

4. A method of controlling pool or spa equipment according to claim 2 in which indirect wireless communication between the controller and the mobile device may occur via a router connected to the Internet.

5. A method of controlling pool or spa equipment according to claim 2 in which indirect wireless communication between the controller and the mobile device may occur via the Internet bypassing any router.

6. A method of controlling pool or spa equipment according to claim 2 in which the mobile device is a hand-held smart phone or tablet and the pool or spa equipment is a pump.

7. A method of controlling a pool or spa pump communicatively connected to a controller, comprising:
a. selectively configuring the controller to communicate wirelessly either directly with a mobile device or indirectly with the mobile device via at least one of a router or the Internet; and
b. wirelessly transmitting information from the mobile device for receipt by the controller and further transmission to the pump.

8. A control system comprising:
a. a mobile device;
b. a controller configured to communicate wirelessly directly with a mobile device; and
c. pool or spa equipment communicatively connected to the controller.

9. A control system according to claim 8 in which the controller is configured also to communicate wirelessly indirectly with the mobile device.

10. A control system according to claim 9 in which indirect wireless communication between the controller and the mobile device may occur via a router disconnected from the Internet.

11. A control system according to claim 9 in which indirect wireless communication between the controller and the mobile device may occur via a router connected to the Internet.

12. A control system according to claim 9 in which indirect wireless communication between the controller and the mobile device may occur via the Internet bypassing any router.

13. A method of controlling pool or spa equipment according to claim 9 in which the mobile device is a hand-held smart phone or tablet and the pool or spa equipment is a pump.

14. A control system comprising;
a. a mobile device;
b. a controller selectively configurable to communicate wirelessly either directly with the mobile device or indirectly with the mobile device via at least one of a router or the Internet;
c. a pool or spa pump communicatively connected to the controller.
